(19) United States
(12) Patent Application Publication
(10) Pub. No.: US 2025/0376742 A1
(43) Pub. Date: Dec. 11, 2025

(54) LITHIUM EXTRACTION FROM SLURRIES BY ADVANCED CARBONATION PROCESSING

(71) Applicants: Jinichiro Nakano, Albany, OR (US); Anna Nakano, Albany, OR (US)

(72) Inventors: Jinichiro Nakano, Albany, OR (US); Anna Nakano, Albany, OR (US)

(21) Appl. No.: 18/738,055

(22) Filed: Jun. 9, 2024

Related U.S. Application Data
(63) Continuation-in-part of application No. 18/738,049, filed on Jun. 9, 2024.

(51) Int. Cl. C22B 26/12; C22B 3/44

(52) U.S. Cl. CPC C22B 26/12; C22B 3/44

(57) ABSTRACT

A low capital and environmentally friendly process of extracting materials from slurries. The method includes adjusting a unique parameter determined based on the modified alkalinity in a quantity of the slurries to a preset value independent of the pH. Interactions of the anionic reactant species with lithium within the slurries causes a solid form of the material to precipitate out of the slurries. After the solid separation, the spent liquid may be returned to underground surface water systems or transported to a storage.

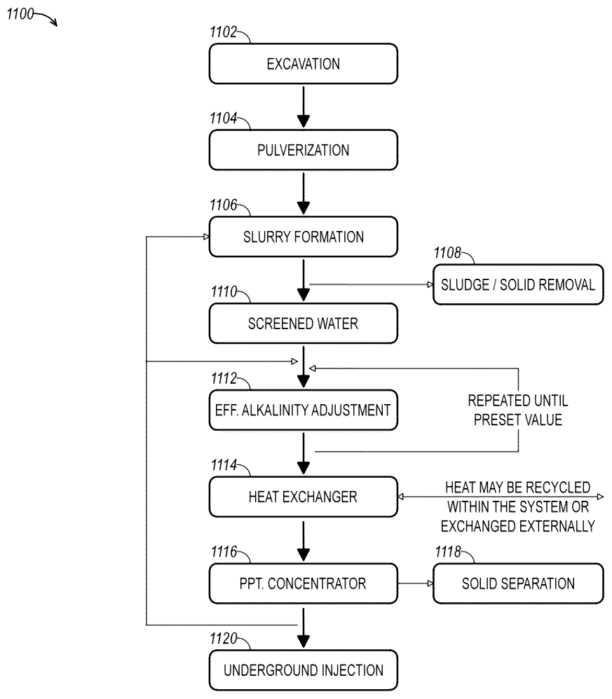

### BACKGROUND OF THE INVENTION

This invention is directed to a process for extracting lithium and forming lithium carbonate from slurries without requiring post-carbonation steps. The lithium is extracted through advanced carbonation processing by adjusting a unique parameter determined based on the modified alkalinity of the slurry to a preset value and recovering the lithium as a precipitate. The precipitate is formed through direct and indirect interactions of the available anionic species with the lithium in the slurries and their surroundings.

The process described herein is a rapid, economical, and environmentally friendly extraction of lithium from slurries. A slurry is a mixture of dense solids suspended in a liquid. The most common use of slurry is as a means of transporting solids, separating minerals, dissolving elements, or fuels, with the liquid being a carrier or reactant. In this case, the slurry can be made with any solutions in addition to water, such as brine, chemically fluxed solutions, base, acid, or a mixture thereof.

Currently, the extraction of alkali metals like lithium from liquids like brines is conducted in two steps: first through the lithium concentration step, which is performed by an evaporation pond route or direct lithium extraction (DLE) techniques, followed by mineralization steps (such as carbonation) typically at separate facilities. Carbonation by advanced CO₂ gas injection into the liquid medium has been suggested in the past few decades by academia and industries for extraction of a variety of metals from liquid media. For this approach to be practically effective, the process has been enhanced by thermodynamic manipulations, for example, pH modification via co-utilization of solid additives or operation under supercritical conditions. The use of microbubbles having a diameter of 50 microns or less was suggested in conjunction with solid additives to promote the carbonation of a liquid to extract metals. The advanced injection of nanobubbles (<1 micron) of gases such as carbon dioxide, ozone, oxygen, air, and nitrogen has been suggested and widely practiced in the past few decades in industries such as materials, agriculture, fishery, medical, pharmaceutical, environmental, biological, cleaning, and sanitation because nanobubbles can adjust the pH or improve the solubility limits (i.e., concentrations) of dissolved gas, the population of suspended gas (e.g., non-dissolved), the surface energy of trapped gas, the surface tension of liquid, wettability, and the charges (e.g., zeta potential) in the vicinity of the trapped gas, while providing the ability to be suspended in a liquid medium for an extended period of time (months to years). Because of such wide applications and uses, various advanced techniques of generating nanobubbles and their injection are commercially available.

The process in this disclosure enables rapid, economical, and environmentally friendly extraction of lithium through carbonation of the supernatant or filtrate of the slurry or directly from the slurry itself (hereinafter in this disclosure, collectively, “Screened Water”) by adjusting the effective alkalinity therein. The adjustment of the effective alkalinity in the Screened Water, if conducted using the process described herein, causes carbonation to generate lithium carbonate (Li₂CO₃) from the Screened Water.

In particular, the process generates lithium carbonate directly from the Screened Water without requiring a pre-concentration step (e.g., evaporation pond and DLE). Adjustment of the effective alkalinity causes the extraction to occur substantially instantaneously. As the process extracts lithium directly from the Screened Water in the form of a carbonate, no subsequent carbonation facility is needed. Consequently, the present invention effectively eliminates the need for transporting materials from a mining site or concentrates (eluates) from a concentration site to a mineralization facility. This results in a significant reduction in economic and environmental burdens (limited production rates, local freshwater consumption, fuel consumption, CO₂ emissions, etc.) in the extraction/carbonation process. It is also envisioned that operation expenses of giga/mega factories for battery manufacturing would be enhanced if they were operated at the source of lithium extraction. Thus, it is useful in the art to provide a low capital and environmentally friendly process of extracting lithium from slurries, as disclosed herein.

### BRIEF SUMMARY OF THE INVENTION

The method includes selecting and adjusting the effective alkalinity in a quantity of the Screened Water to a preset value. Alkalinity, in general, is a measurement of dissolved alkaline substances, which may represent the capacity or ability of a liquid medium to neutralize acids so that the pH does not abruptly change. The effective alkalinity, as defined in this disclosure, is used to activate existing anions and cations to cause a new state of equilibrium (or metastable equilibrium) in the Screened Water to enable precipitation of the lithium without needing to purposefully modify the pH of the Screened Water.

Alkalinity, in general, may be expressed in units of concentration. For the purpose of this disclosure, concentrations of the following species are considered in the effective alkalinity determination, which may be as an individual, a combination, or a total: carbonate and other carbonic species (e.g., CaCO₃, CaMg(CO₃)₂, CO₃²⁻, HCO₃³⁻); silicate and other silicon species (e.g., SiO₂, SiO(OH)₃⁻); borate and other boron species (e.g., B(OH)₄⁻); hydroxide species (e.g., OH⁻); and chlorine species (e.g., HOCl, HCl). In some embodiments, alkalinity is modified, which is a partial total alkalinity defined in this disclosure as the balanced concentrations: [HCO₃⁻]+2[CO₃²⁻]+[CaCO₃]+[CaMg(CO₃)₂]+[B(OH)₄⁻]+[OH⁻]+[SiO (OH)₃⁻]+[NH₃]−[H⁺]−[HF]−[HOCl]−[HCl].

The effective alkalinity (A_{eff}) in this disclosure is defined as:

$$\{ ( the alkalinity of a liquid ) + ( protonation donors ) \} / \{ ( the sum of concentrations of anions with charges of 2 - or higher ) + ( the sum of concentrations of dissolved species in the liquid ) \} .$$

In some embodiments, the effective alkalinity may be simplified as the ratio of the alkalinity to the concentration of dissolved species.

In one embodiment, the preset effective alkalinity is in a range of 0.022-13.055. In another embodiment, the preset effective alkalinity is in the range of 0.062-10.05. In another embodiment, the preset effective alkalinity is in the range of 0.11-8.57.

The effective alkalinity expressed this way can effectively enable the determination of desired carbonation for lithium. A non-limiting example includes:

$${A}_{eff} = \{ ( [ {HCO}_{3}^{-} ] + 2 [ {CO}_{3}^{2 -} ] + [ {CaCO}_{3} ] + [ {CaMg ( {CO}_{3} )}_{2} ] + [ \text{} {B ( OH )}_{4}^{-} ] + [ \text{} {OH}^{-} ] + [ {SiO ( OH )}_{3}^{-} ] - [ {H}^{+} ] - [ HF ] - [ HOCl ] - [ HCl ] ) + ( [ {H}^{+} ] ) \} / \{ ( 2 [ {CO}_{3}^{2 -} ] ) + ( {CaCO}_{3} + {CaMg ( {CO}_{3} )}_{2} + {SiO}_{2} + {CO}_{x} + {C}_{x} {H}_{y} ) \} \qquad Eq . 1$$

Note the total alkalinity component in this equation, if charges and protons are balanced, should not be affected by the pH, temperature, and pressure.

When the effective alkalinity is optimally adjusted, the following exemplified elemental reaction for lithium carbonation is promoted:

$$2 {Li}^{+} + {C}^{4 +} + 3 {O}^{2 -} = {Li}_{2} {CO}_{3} \qquad Eq . 2$$

Non-limiting resource examples for Li⁺ may include Li ions, LiCl, LiOH, LiOH·H₂O, Li₂CO₃, Li₂O, and lithium-bearing minerals. Non-limiting resource examples for C⁴⁺ may include carbonic species, carbonates, air, and trapped air. Non-limiting resource examples for O²⁻ may include carbonic species, carbonates, oxygen-bearing ions, oxygen-bearing compounds, dissolved oxygen, air, and trapped air.

The effective alkalinity adjustment may be performed by controlling concentrations of species mentioned in and by any known means or chemical reactions induced by, for example, carbonation and decarbonization.

Carbonation and decarbonization can be conducted with the carbonic species, which may originate from, produced by, or controlled by interactions with carbonic solids, gases, and liquids, or those containing carbonic species such as alkali carbonates, ultrafine gaseous carbonic spheroids having a diameter of ≤999 nanometers, dissolved carbonic gases, and respective ions. The carbonic species may be removed by any existing means, such as flotation and known chemical reactions.

### BRIEF DESCRIPTION OF THE DRAWINGS

A process flow diagram of the invention.

### DETAILED DESCRIPTION OF THE INVENTION

The disclosed process will become better understood through a review of the following detailed description in conjunction with the figure. The detailed description and the figure provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

The overall process and preferred embodiment (1100) is illustrated in the figure. First, the solids are excavated (1102) and pulverized (1104). Second, a slurry is formed by blending the pulverized material with any liquid solution, such as water, brine, chemically fluxed solutions, base, acid, or a mixture thereof (1106). The liquid medium may be selected in a way to maximize lithium dissolution. Certain materials, including lithium and/or lithium-containing components, dissolve in the liquid solution. Dissolution and/or dissociation energy from the slurry may be harvested and/or utilized for further dissolution/dissociation or chemical reactions in this invention or where needed. Third, the solids and sludge are removed from the slurry by any known methods (1108) providing Screened Water (1110).

Next, the effective alkalinity (A_{eff}) in the screened water is adjusted toward a preset value (1112), which may be repeated until the preset value is obtained. In one embodiment, a preset value for the effective alkalinity is determined in such a way that a total mass of available carbonic species (ionic, aqueous, and dissolved) in the Screened Water is equal to or higher than that determined by the stoichiometry of the final product. In the first embodiment, an alkalinity in the range of 2-200 mg/L CaCO₃ is preferred. In the second embodiment, alkalinity in the range of 100 to 500 mg/L CaCO₃ is more preferred. In the third embodiment, an alkalinity in the range of 300 to 1,000 mg/L CaCO₃ is most preferred.

The brine then undergoes a heat exchanger where heat is exchanged within the system or externally to adjust the temperature of the Screened Water to a preset value (1114). The lithium in the Screened Water with the adjusted effective alkalinity reacts with the anions and precipitates as solid Li₂CO₃. In some embodiments, the anions are available in the Brine and surroundings. The Screened Water with the precipitates undergoes a concentrator to concentrate Li₂CO₃ materials (1116) and separated at (1118). Concentration and separation can be performed by any conventional means, including gravitational, density, centrifuge, flotation, filtration, charge, surface tension, membrane, screening, absorption, adsorption, and electrostatic. The screened water after solid separation may be returned to the main stream before (1112) and/or utilized at the slurry formation step (1106). The spent screened water after (1116) may be injected underground (1120), moved to surface water systems, or transported to storage units.

### DEFINITIONS

The following definition applies herein, unless otherwise indicated. For the purposes of this disclosure, carbonic species or reactant carbonic species includes: aqueous species with non-limiting examples including carbonic acid, bicarbonate, and carbonate; gaseous species such as carbon monoxide, carbon dioxide, and hydrocarbons; dissolved gaseous species; anionic forms of gaseous species; cationic forms of gaseous species; and protonated and deprotonated forms of gaseous species.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and sub-combinations of the various elements, features, functions, and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and sub-combinations of the disclosed inventions that are believed to be novel and non-obvious. Inventions embodied in other combinations and sub-combinations of features, functions, elements, and/or properties may be claimed through amendment of those claims or presentation of new claims in the present application or in a related application. Such amended or new claims, whether they are directed to the same invention or a different invention and whether they are different, broader, narrower, or equal in scope to the original claims, are to be considered within the subject matter of the inventions described herein.

1. A method for extracting lithium from slurries comprising:
providing a slurry;
adjusting the effective alkalinity in the slurry to a preset value using at least one effective alkalinity adjustment step;
precipitating the lithium from the slurry; and
exchanging heat with the slurry using at least one heat exchanger step.

2. The method of claim 1, where the precipitate is lithium carbonate or a carbon-bearing compound comprising lithium.

3. The method of claim 1, where the effective alkalinity is the ratio of the alkalinity to the concentration of dissolved species.

4. The method of claim 1, where the effective alkalinity is in a range of 0.022-13.055.

5. The method of claim 1, where the preset effective alkalinity is in the range of 0.062-10.05.

6. The method of claim 1, where the preset effective alkalinity is in the range of 0.11-8.57.

7. The method of claim 1, wherein adjusting the effective alkalinity is preceded by selecting the reactant species for lithium to be recovered.

8. The method of claim 1, further comprising screening the slurry to produce a screened liquid prior to adjustment of the effective alkalinity.

9. The method of claim 8 where the slurry is replaced by or mixed with the screened liquid.

10. The method of claim 9, where the spent screened liquid is returned to the mainstream at a preset ratio before the effective alkalinity adjustment.

11. The method of claim 9, where the spent screened liquid is utilized in the slurry formation at a preset ratio.

12. A method for extracting lithium from slurries comprising:
creating a slurry by mixing a pulverized solid material with a liquid;
separating the liquid from the solid material;
adjusting the effective alkalinity in the slurry to a preset value using at least one effective alkalinity adjustment step;
precipitating the lithium from the slurry; and
exchanging heat with the slurry using at least one heat exchanger step.

13. The method of claim 12, where the effective alkalinity is in a range of 0.022-13.055.

14. The method of claim 12, where the preset effective alkalinity is in the range of 0.062-10.05.

15. The method of claim 12, where the preset effective alkalinity is in the range of 0.11-8.57.

16. A method for extracting lithium from slurries comprising:
creating a slurry by mixing a pulverized solid material with a liquid;
separating the liquid from the solid material;
adjusting the effective alkalinity in the slurry to a preset value using at least one effective alkalinity adjustment step;
precipitating the lithium from the slurry;
exchanging heat with the slurry using at least one heat exchanger step;
concentrating the lithium using at least one material concentration step;
separating the lithium; and
exiting the spent slurry from the system.

17. The method of claim 16, where the effective alkalinity is in a range of 0.022-13.055.

18. The method of claim 16, where the preset effective alkalinity is in the range of 0.062-10.05.

19. The method of claim 16, where the preset effective alkalinity is in the range of 0.11-8.57.
